(19) United States
(12) Patent Application Publication
(10) Pub. No.: US 2017/0014204 A1
(43) Pub. Date: Jan. 19, 2017

(54) Dental framework

(71) Applicant: René Daher, Geneva (CH)

(72) Inventor: René Daher, Geneva (CH)

(73) Assignee: René Daher

(21) Appl. No.: 14/798,736

(22) Filed: Jul. 14, 2015

(51) Int. Cl. A61C 5/00

(52) U.S. Cl. CPC A61C 5/005

(57) ABSTRACT

A specialized dental device or framework used to join and to stabilize remaining tooth structures together in order to reduce, limit or eliminate the small movements or elasticity of the tooth tissues or restorative materials by opposing to the forces generated on the tooth and restorations. The use of the actual device or framework is not limited to joining only tooth structures together, but it could also be used to join and reinforce the tooth structures and the restorative material. To adapt to the different possible clinical shapes, it will exist in different versions, depending on the shape, volume and type of remaining tooth surfaces. It could be made of any kind of materials, such as fiber-reinforced composite, ceramic, gold, zirconia or any other type of materials.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present invention relates to the dental field, and more particularly to reinforcing and enhancing the quality of the tooth and the restoration.

The hard tissues forming the tooth are enamel and dentin. Enamel is the hardest tissue present in the human body, even harder than bone. Although the tissues forming the tooth are hard, very small movements and elasticity of these tissues are still present when the tooth gets is contact with the opposing tooth (also known as antagonist tooth) or even food for example. When a tooth has a decay or carie (also known as cavity), the dentist has to drill the tooth in order to clean that decay. This removal of tooth substance leads to an increase in these small movements and deflections. Moreover, in some cases, the dentist sometimes needs to drill the tooth more in depth in order to gain access to the dental nerve (also known as the dental pulp or endodontic system) so it could be cleaned and filled; this is known as the root canal or endodontic treatment. Root canal treatment leads to an even higher increase in these small movements and deflections due to the large removal of tooth substances. These repeated small movements under daily mastication and other oral functions, increase the fracture risk of the tooth and make the root canal treated teeth as one of the main reasons of losing teeth. Small movements also exist at the interface between the dental restoration (like the fillings and crowns) and the tooth since these restorations are often bonded with adhesives. This leads to a deterioration of the interface after some time, which then creates empty spaces which could make way for bacterial reinfection and recurring caries (also known as secondary carie).

To avoid these problems in such cases, the dental literature recommends the need to drill the parts of the tooth that are in contact with the antagonist teeth and cover it with an artificial restoration; this is known as cusp coverage restoration. In other cases, it is recommended to prepare the tooth for a crown. This has shown to be efficient techniques to reduce the fracture risk of the tooth, but it also involves the removal of additional tooth substances which mostly are still healthy and decay free, which is an invasive procedure. This same technique also requires more time and the need for a dental technician or machine to produce the indirect dental restoration, which also means an increase of the cost for the patient.

The prior art in this field has also seen technological advancements related to the dental apparatus, and more particularly to dental “post and core assemblies” for use in the formation of a dental core as part of the restoration of a tooth structure, and specifically to devices commonly known as post and core systems as well as impression transfer posts for restoration of teeth. This is patented under U.S. Pat. No. 4,820,159.

Another invention, patented under U.S. Pat. No. 6,334,775 B2 discloses continuous fibers, resin-fiber pastes or continuous fiber-reinforced preforms inserted into tooth cavities to form high-strength dental restorations. Such reinforcements use conventional filling material such as resins and glass ionomers and they help in increasing toughness and elasticity and are also aesthetic and also shrink little during the hardening of final restoration.

U.S. Pat. No. 4,778,389 discloses a dental post to eliminate lateral stress in a tooth wherein a rigid, split post is formed by parallel sections joined at a marginal top portion of the post head.

U.S. Pat. No. 4,936,776 discloses a translucent post and core to minimize discoloration next to a dental restoration.

U.S. Pat. No. 4,622,012 discloses a dental post system with a hollow post used to fill the canal with composite and an inner post to construct the core.

The previously mentioned inventions can be useful in some situations, as they have applications in creating retentions for the restoration material, or to reduce the stress or forces on the restoration. But none of these systems have described a method to stabilize the remaining tooth structures by linking them together and reducing or eliminating the deflection of the remaining tooth walls, and between the restoration and the tooth.

The present invention describes a dental device or framework that is used to join, reinforce and stabilize the remaining tooth structures of a tooth and also the restorative material by limiting the previously mentioned small movements, without the need of an invasive treatment requiring the previously described cusp coverage restoration technique. More specifically, it presents a technique for protecting the remaining tooth structures with a minimally invasive procedure, which could then permit the dentist to restore the tooth in a direct filling or a restoration, without having to pass through the dental lab technician or a machine. The present invention also stabilizes the restoration to the tooth in order to limit the small movements and elasticity of the interface.

To the best knowledge of the inventor, no such pre-existing invention discloses such comprehensive features as are used in this invention. Nowadays, a lot of the restorative procedures recommend not leaving any thin wall of the remaining tooth structure that could break during mastication, or even suggest shortening these walls, and covering them with any kind of restorations, such as crowns. This particular invention is commercially, medically and personally an advantage over such traditional systems. It increases the resistance to fracture and enhances the quality of the interface between the tooth and restoration, without the need of eliminating intact tooth tissues like dentists are obliged to do now while preparing for a conventional crown or onlay.

The limitation and non-effectiveness of the prior art has been overcome by the instant invention as described below.

### BRIEF SUMMARY OF THE INVENTION

The foregoing descriptions outline some features and objects of the present invention. These may be illustrative of more exhaustive and comprehensive features described later in the application.

The present invention describes a specialized dental device or framework that is used to join and stabilize remaining tooth structures together. It also permits the stabilization of the restorative material to the remaining tooth structures. The device will either be internally placed in the tooth and restoration or externally in a way to oppose to the forces displacing the tooth structures and the restoration.

In a preferred embodiment, the structure includes a head or multiple heads adapted to engage one tooth structure, a body that could pass through the restorative material or retain it and a tip or multiple tips adapted to engage other remaining tooth structures, a restoration, or even another framework.

In another preferred embodiment, the device or framework is set to adapt to different possible clinical shapes of remaining tooth structures, and it will exist in different versions, depending on the shape, volume and type of remaining tooth surface. It could for example be in the shape of a ring or net bracing the tooth of part of it to stabilize it.

Further, to adapt to different types of restorative materials or techniques, the device or framework could be made of any kind of materials, such as fiber reinforced composite, ceramic, gold, zirconia or any other type of materials.

It is an objective of the present disclosed invention to reduce or limit the micro or very small movements of the remaining tooth structures during function (mastication, phonation, etc.). This reduction of elasticity of the remaining tooth structures will increase the durability of the tooth by reducing the fatigue. It will also increase the quality of the restoration, since the interface between the restorative material and the tooth structures will be more stable and less dynamic. This will mean that the fracture resistance of the tooth will increase, and the quality of the marginal adaptation of the restorative material will also increase.

It is an objective of the present disclosed invention to provide best curative technique for restoring teeth. The invention prevents any possible or augmented risk of fractures that may occur due to weakening of tooth structures and enhances the quality and durability of the restoration. This invention is adapted to different clinical shapes and is best-suited and convenient for dentists or dental surgeons to perform the restoration. It is also a medically and commercially viable option for the patients.

These and other features, objects and advantages of the present invention will be readily visible to the persons ordinarily skilled in the art related to this field comprehending in entirety the above characteristics, following descriptions and claims of the present invention.

### BRIEF DESCRIPTION OF THE DRAWINGS

FIG. 1 shows a perspective view of one possible design of the dental framework where the head is tapered and both head and tip present depressions.

FIG. 2 illustrates a lateral view of the framework of FIG. 1.

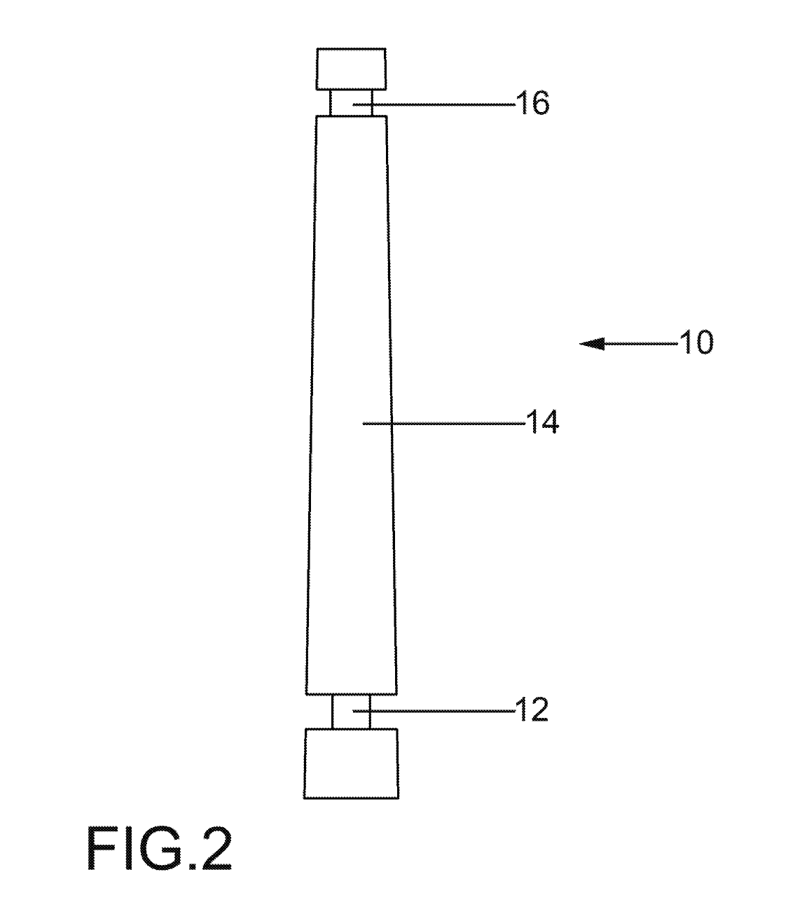

FIG. 3 presents a side view of four of the many possible configurations of the head of the framework.

FIG. 4 illustrates a perspective view of four of the many possible configurations of the framework.

### DETAILED DESCRIPTION AND BEST MODE OF IMPLEMENTATION

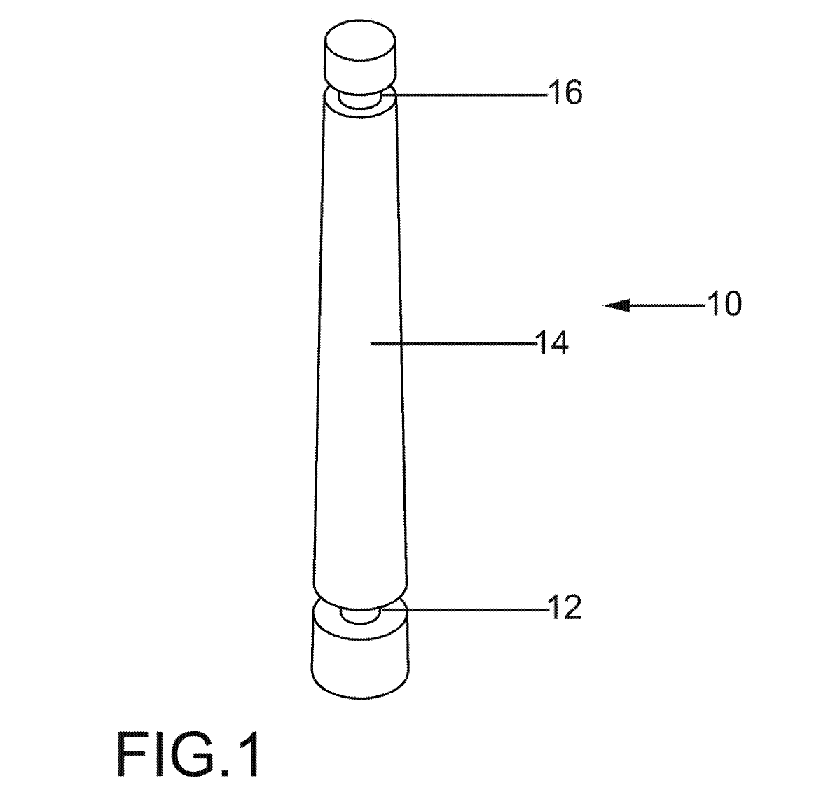

Referring now to the drawing in detail wherein like reference numerals have been used in all figures to designate like elements, there is shown in FIG. 1 a simple version of the dental stabilizing framework constructed in accordance with the principles of the present invention and designated generally as 10. In FIG. 1, framework 10 is an axially extending zirconia post with one head 12 to engage one tooth surface, one simple body 14 to pass through a restoration material, and one simple tip 16 to hold on to another tooth surface. This will permit to create an opposing reaction to the forces that will tend to bend the walls towards the outside.

At least one of the three previously mentioned portions 12, 14 or 16 has to engage in tooth structure or to surround it in order to add stability to the tooth 20. As is well known in the art, dental materials can engage and stick to tooth structures by different means; it could be by the use of an adhesive, a special joint, mechanical retention, or multiple other ways. This process per se is well known, and it will be used to fix the device or the framework to the tooth structures, restorative materials or other frameworks.

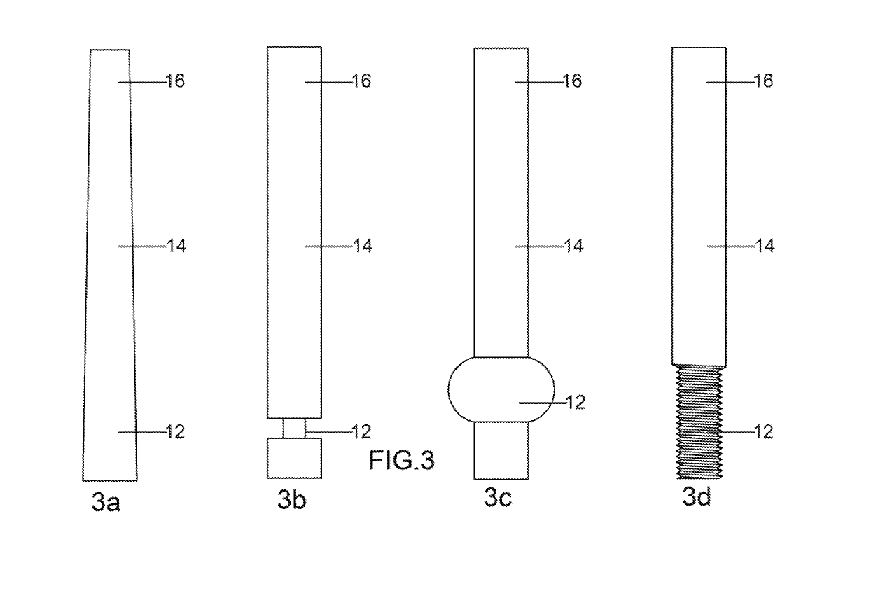

The head 12, the body 14 and the tip 16 of the dental framework 10 can have different configurations. For example, it can either be tapered, have a groove, have a screw thread or a depression as shown in FIG. 3. It can be also made of a different material than the rest of the framework.

The design 3a in FIG. 3 is the same as the one shown in FIG. 1. The portion 12 is tapered, and could then be locked in a retentive tapered hole made in the tooth structure. One useful application of this design would be to prohibit micro-movements of the tooth structure and reinforce it. Another feature of this design is the minimal size of the hole necessary in the tooth 20, and the possibility to remove the excess of the head 12 coming out of the tooth while maintaining the retention.

In the design 3b in FIG. 3, the portion 12 presents a groove that will engage in the tooth structure. This groove could for example be locked in the tooth by filling the gaps with a restorative material in order to obtain some retention.

In the design 3c in FIG. 3, the portion 12 presents a depression that will engage in the tooth structure. This depression could for example be locked in the tooth by filling the gaps with a restorative material in order to obtain some retention.

In the design 3d in FIG. 3, the portion 12 presents a thread that could be screwed into the tooth structure for example, it could also go through a tooth structure and be fastened by a nut on the other side.

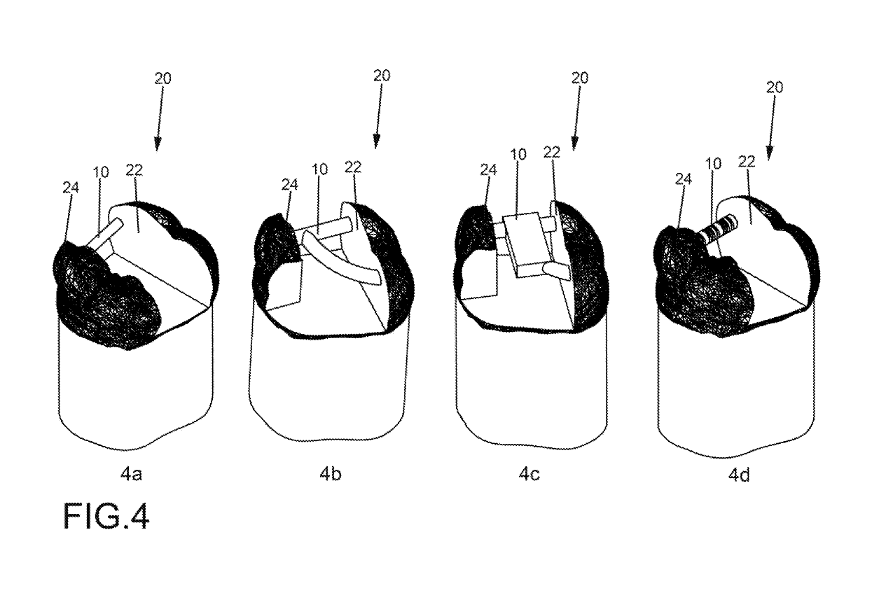

The shape of the dental framework 10 shown in FIG. 1 is, of course, by way of example only. In this invention, the length, shape and angles between the three sections 12, 14 and 16 of the framework can also be adapted to different common uses as shown in the designs 4a, 4b, 4c and 4d of FIG. 4. For example, if the goal is to stabilize only one side of a tooth wall 22 to another side of another tooth wall 24, the framework could have one head 12 and one tip 16 as shown in the design 4a of FIG. 4. When the framework is being used to hold together two sides of a wide tooth wall to a narrow tooth wall 24, the framework will have for example two heads 12 and one tip 16 as shown in the design 4b of FIG. 4.

If more surface is needed in the middle part of the tooth for example, the body 14 would have a wide flat surface as shown in the design 4c in FIG. 4. This would increase the surface of adhesion in some cases, or improve the mechanical properties of the tooth.

In some other cases for example, the body 14 could have grooves to help retain better the restorative material as shown in the design 4d of FIG. 4. The framework could also be on the form of a ring or a net that surrounds the tooth or part of the tooth to limit the deflection movements.

What is claimed is:

1. A dental device or framework used to reduce, limit or even eliminate all the small movements and elasticity of the dental tissues and the restoration materials by opposing to the forces generated on the tooth and the restoration, comprising of:
a. A head or multiple heads adapted to engage in or to surround tooth structure.
b. A body that could pass through the restorative material.
c. A tip or multiple tips adapted to engage in or to surround other remaining tooth structures, a restoration, or even another device or framework.

2. A dental device or framework as recited in claim 1, wherein the head or multiple heads engage mechanically in tooth structure.

3. A dental device or framework as recited in claim 1, wherein the head or multiple heads are bonded in tooth structure.

4. A dental device or framework as recited in claim 1, wherein the head or multiple heads surround or envelope tooth structure.

5. A dental device or framework as recited in claim 1, wherein the body part can retain the restorative material.

6. A dental device or framework as recited in claim 1, wherein the body part can pass around the restorative material.

7. A dental device or framework as recited in claim 1, wherein the head, body and tip are designed to adapt to different possible clinical shapes of remaining tooth structures depending on the shape, volume and type of remaining tooth surface including but not limited to the shape of a ring or a net bracing the tooth.

8. A dental device or framework as recited in claim 1, wherein the head, body and tip can be made of any kind of materials including but not limited to fiber reinforced composite, ceramic, gold, and zirconia.

9. A dental device or framework as recited in claim 8, wherein the head, body and tip are made of the same material.

10. A dental device or framework as recited in claim 8, wherein the head, body and tip are made of different materials.
